(19) United States
(12) Patent Application Publication
(10) Pub. No.: US 2005/0046703 A1
(43) Pub. Date: Mar. 3, 2005

(54) Color calibration in photographic devices

(76) Inventor: Ross G. Cutler, Duvall, WA (US)

Correspondence Address: James R. Banowsky, One Microsoft Way, Redmond, WA, 98052, US

(21) Appl. No.: 10/955,850

(22) Filed: Sep. 30, 2004

Related U.S. Application Data
(63) Continuation-in-part of application No. 10/177,315, filed on Jun. 21, 2002.

(51) Int. Cl. H04N 9/73

(52) U.S. Cl. 348/223.1

(57) ABSTRACT

A camera samples an image area that includes an active region that encompasses a captured photographed image and an extended region. The extended region includes a reference object that is fixed to the camera and is sampled with the photographed image. An image of the reference object is referenced and used for one or more color calibration procedures, such as white balancing, black level calibration, and red and blue channel gains. In a multi-camera configuration, each camera includes a reference object and color calibration is performed for each camera to achieve near-seamless mosaic panoramic images.

### CROSS-REFERENCE TO RELATED APPLICATION

This application is a continuation-in-part of U.S. patent application Ser. No. 10/177,315, entitled “A System and Method for Camera Color Calibration and Image Stitching”, filed Jun. 21, 2002 by the present inventor and assigned to Microsoft Corp., the assignee of the present application. Said application is hereby incorporated by reference.

### TECHNICAL FIELD

The following description relates generally to image processing. More particularly, the following description relates to calibration of one or more camera controls.

### BACKGROUND

White balance is a camera control that adjusts a camera's color sensitivity to match the prevailing color of ambient light. Without calibration, a camera cannot tell the difference in color between indoor lighting, a rainy day or a bright sunny day. Prior to white balancing, bright daylight tends to look blue, incandescent light looks yellow, and fluorescent lighting looks green. The human eye adapts very quickly to the color temperature variations in these light sources, which makes the differences nearly imperceptible. However, cameras cannot do so.

White balancing basically consists of showing the camera something that should look white and using that as a reference point so that all the other colors in the scene will be reproduced accordingly. One technique that photographers have used to white balance cameras is to manually photograph a white card and adjust red and blue gains in the camera to recognize the card as true white. Another way of adjusting the white balance has been for a camera to detect a white region in an image area and then adjust the red and blue channel gains according to that region.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a block diagram depicting an exemplary general purpose computing/camera device.

FIG. 2 is a block diagram representing an exemplary photographic device.

FIG. 3a is a representation of an exemplary image area having an active region, an extended region and a reference object.

FIG. 3b is a representation of an exemplary image area having an active region, an extended region and a multi-color reference object.

FIG. 4a is a diagram of an exemplary panoramic multi-camera configuration.

FIG. 4b is a diagram of an exemplary inverted pyramidal mirror from the multi-camera configuration.

FIG. 5 is a flow diagram of an exemplary process for white balancing a photographic image.

### DETAILED DESCRIPTION

Without adjustments for various conditions, cameras do not adapt to subtle differences between various types of lighting that affect colors of photographed images. A camera that depicts a true white object correctly in indoor light will depict the same white object differently if photographed outdoors in bright sunlight. This difference, if unaccounted for, will result in a photograph of poor color quality.

To overcome such lighting differences, cameras provide for white balancing. White balancing is a camera control that adjusts a camera's color sensitivity to match the prevailing color of ambient light. Basically, white balancing consists of showing the camera something that should look white and using that as a reference point so that all the other colors in the scene will be reproduced accordingly.

White balancing becomes even more of an issue with regard to panoramic cameras that combine several images into a single image, or omni-directional camera configurations that utilize more than a single camera. When acquiring images for a panoramic image from a single camera, the camera can be adjusted to have settings as similar as possible for all images acquired. But there can still be differences in color between images due to lighting factors and other conditions that may change over the course of time or when photographing from different angles or perspectives.

In a multi-camera configuration, an image mosaic or panorama is created by combining an image taken by each camera to form a single image. If the white balance of one camera differs from the white balance of another camera, then discontinuities in the single image will appear between the individual images at locations where the images are “stitched” together. Besides the factors listed above that may cause differences in individual images, variations between camera components such as Charge Coupled Devices (CCD), A/D (Analog to Digital) converters, and the like can cause significant image variations between cameras. As a result, the mosaic composite image can often exhibit distinct edges where the different input images overlap due to the different colors of the images.

In the description provided below, a camera samples an active image region and an extended region. The active image region includes the image to be processed. The extended region includes a reference object that is detected by the camera but does not show up in a photographic image produced by the camera. The reference object is usually—but not necessarily—a shade of white. When white balancing is desired, the camera is configured to perform white balancing utilizing the reference object for reference.

In a multi-camera configuration, white balancing is performed for each camera by adjusting red and blue gains so that the average red, blue and green pixels in the region of the reference object are equal. This achieves a near seamless panoramic image.

In at least one other implementation, there is overlap between the individual images produced in a multi-camera configuration. After the previously described white balancing is achieved, the overlapping areas between images can be used to fine-tune the color balancing as described in U.S. patent application Ser. No. 10/177,315, entitled “A System and Method for Camera Color Calibration and Image Stitching”, filed Jun. 21, 2002 by the present inventor and assigned to Microsoft Corp., the assignee of the present application.

It is noted that the reference object used for white balancing does not necessarily need to be perfectly white. In fact, the reference object could be another color, such as gray, green, etc. As long as the color of the reference object is known and has a good response in each color channel (i.e., red or blue would be a poor choice), the white balancing techniques described herein are applicable.

Other color adjustments can be made using a reference object of a different color. A black reference object, for example, can be used to set a black level setting in a camera. Red, blue and green reference objects can be used to adjust red and blue channel gains in a camera. In one or more implementations, multiple reference objects are utilized for different purposes. For example, a camera may include a white reference object for white balancing and a black reference object for black level settings.

It is noted that, when discussing multiple reference objects below, such reference also includes a single physical object that comprises multiple colors. For example, a reference object may have distinct sections of color, e.g. white, black, red, blue, green, etc. Such a multi-color reference object may be referred to as a single reference object or as multiple reference objects.

Exemplary Operating Environment

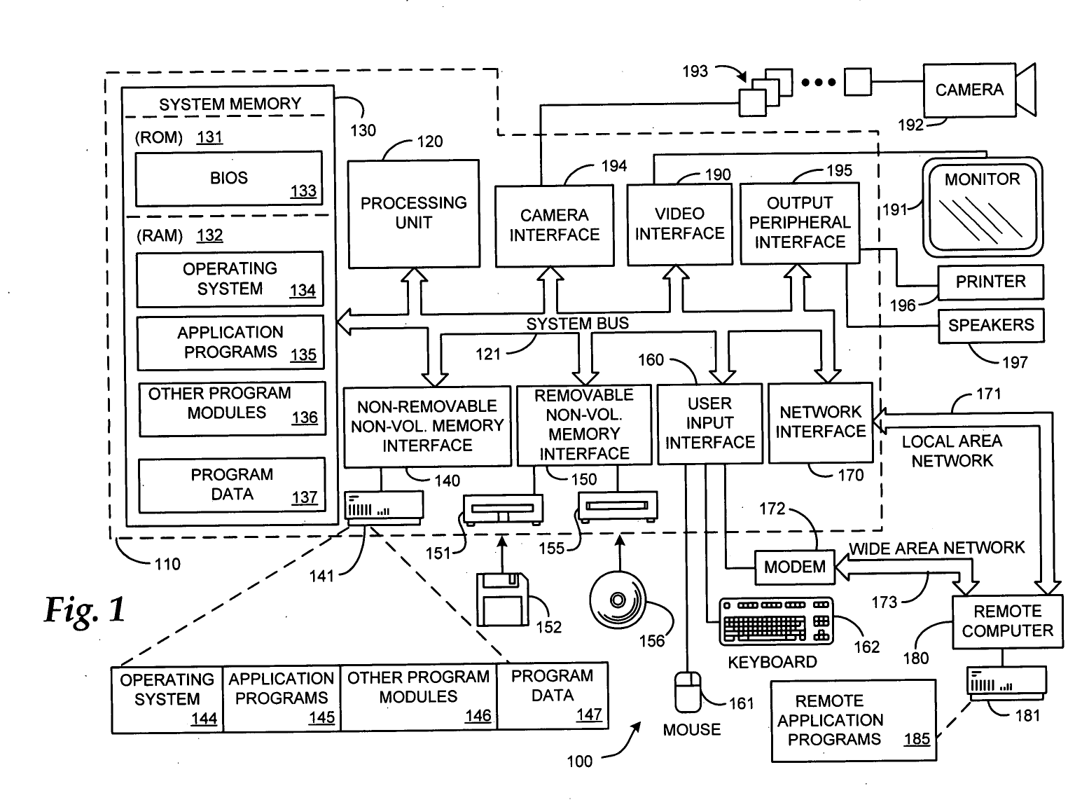

FIG. 1 is a block diagram depicting a general purpose computing/camera device. The computing system environment 100 is only one example of a suitable computing environment and is not intended to suggest any limitation as to the scope of use or functionality of the claimed subject matter. Neither should the computing environment 100 be interpreted as having any dependency or requirement relating to any one or combination of components illustrated in the exemplary operating environment 100.

The described techniques and objects are operational with numerous other general purpose or special purpose computing system environments or configurations. Examples of well known computing systems, environments, and/or configurations that may be suitable for use include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The following description may be couched in the general context of computer-executable instructions, such as program modules, being executed by a computer. Generally, program modules include routines, programs, objects, components, data structures, etc. that perform particular tasks or implement particular abstract data types. The described implementations may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing the invention includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through anon-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 110 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus 121, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195. Of particular significance to the present invention, a camera 163 (such as a digital/electronic still or video camera, or film/photographic scanner) capable of capturing a sequence of images 164 can also be included as an input device to the personal computer 110. Further, while just one camera is depicted, multiple cameras could be included as an input device to the personal computer 110. The images 164 from the one or more cameras are input into the computer 110 via an appropriate camera interface 165. This interface 165 is connected to the system bus 121, thereby allowing the images to be routed to and stored in the RAM 132, or one of the other data storage devices associated with the computer 110. However, it is noted that image data can be input into the computer 110 from any of the aforementioned computer-readable media as well, without requiring the use of the camera 163.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

Exemplary Photographic Device

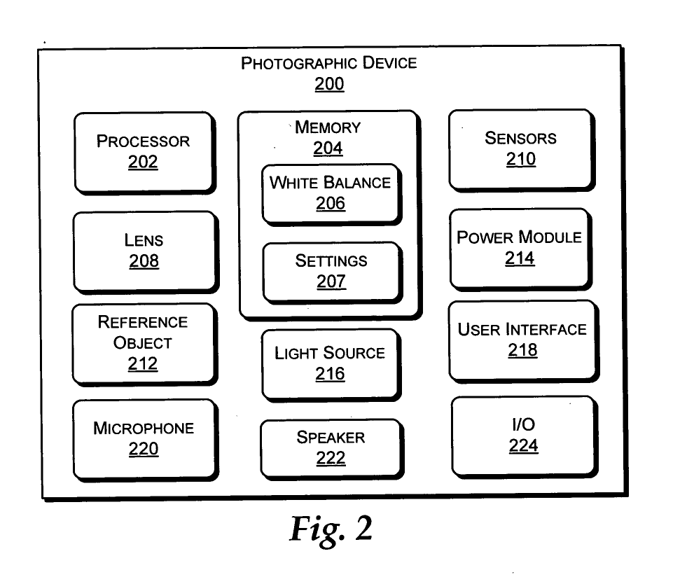

FIG. 2 is a block diagram representing an exemplary photographic device 200, which includes a processor 202 and memory 204 that stores a white balancing application 206 and other applications (not shown) such as an operating system, a digital photography application or the like. The memory 204 stores one or more control settings 207 for color balancing including red and blue channel gains. The exemplary photographic device 200 also includes at least one lens 208 and one or more sensor 210. The lens 208 may include one or more mirrors (not shown) as a part thereof if required in a particular configuration.

The sensor 210 is configured to convert light into electrical charges and is similar to image sensors employed by most digital cameras. The sensor 210 may be a charge coupled device (CCD), which is a collection of light-sensitive diodes, called photosites, which convert photons into electrons. Each photosite is sensitive to light—the brighter the light that hits a single photosite, the greater the electrical charge that will accumulate at that site. The accumulated charge of each cell in the image is read by the CCD thereby creating high-quality, low-noise images. Unfortunately, each photosite is colorblind, only keeping track of the total intensity of the light that strikes its surface. To get a full color image, most sensors use filtering to look at the light in its three primary colors—red, green and blue (RGB) or cyan, magenta and yellow (CMY). The output of the multiple color filters are combined to produced realistic color images. Adjusting color in an image taken by a digital camera is typically accomplished by adjusting brightness, contrast and white balance settings.

The exemplary photographic device 200 also includes a reference object 212 in accordance with the previous description thereof. The reference object 212 is a physical piece of white material (or other appropriate color) that is located so that it can be detected by the sensor 210. When white balancing is performed, the sensed image of the reference object 212 is taken into account and a white balancing operation is performed based on the reference object 212. The reference object 212 and white balancing will be described in greater detail below.

The exemplary photographic device 200 also includes a power module 214, a light source 216 and a user interface 218. The power module 214, may incorporate a transformer or one or more batteries that power the exemplary photographic device 200. The light source 216 may be a flash or continuous light capable of illuminating a photographic subject. The user interface 218 may include buttons, LEDs (Light Emitting Diodes), LCDs (Liquid Crystal Displays), displays, touch screen displays, and/or the like to allow a user to interact with settings and controls.

The exemplary photographic device 200 may also include one or more microphones 220, one or more speakers 222 and one or more input/output (I/O) units 224, such as a network interface card (NIC) or a telephonic line—especially if the photographic device is a video conference type camera.

The elements shown and describe in FIG. 2 and their functions are discussed in greater detail below, with respect to subsequent figures.

Exemplary Image Area

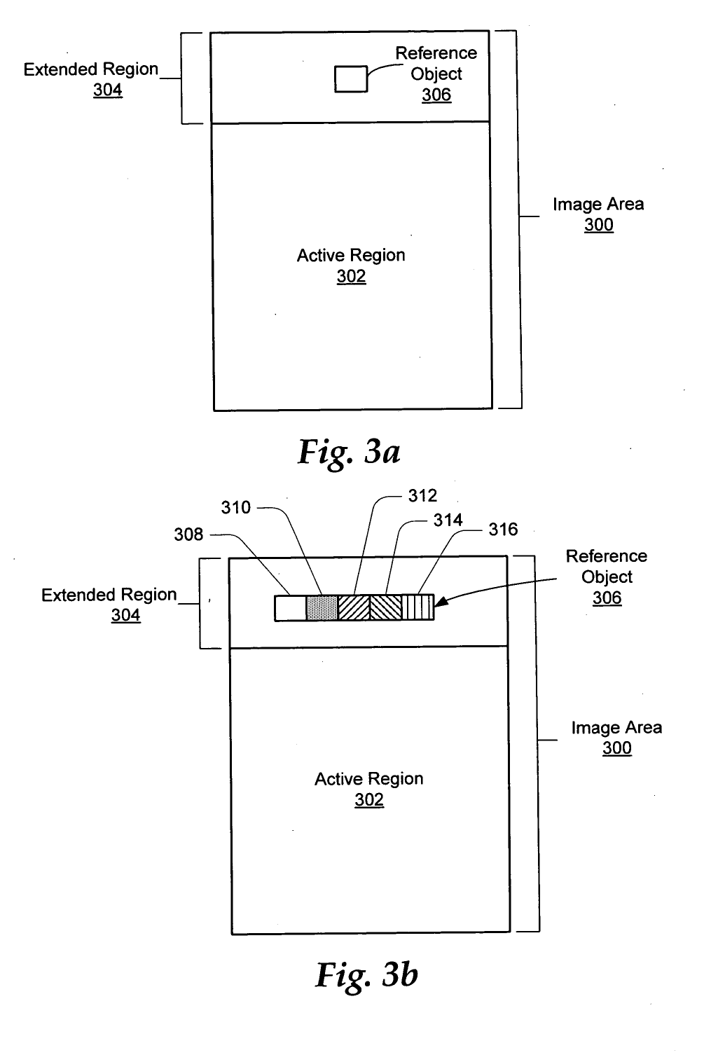

FIG. 3a is a representation of an exemplary image area 300 having an active region 302 and an extended region 304. In the following discussion, continuing reference is made to the elements and reference numerals shown and described in FIG. 2.

The image area 300 is an image that is detected by the sensor 210 of the exemplary photographic device 200. An image ultimately produced by the exemplary photographic device 200 shows only what is detected in the active region 302 of the image area 300. The extended region 304, while detected by the sensor 210, is not included in a produced image.

A reference object 306 is located within the extended region 304 so that the reference object 306 can be detected by the sensor 210 but not included in an image produced by the exemplary photographic device 200. For best results, the reference object 306 should comprise an area of at least four pixels by four pixels (i.e. sixteen pixels). Consequently, the extended region 304 should include an area of at least this size or larger so that the reference object 306 is clearly discernable as being distinct from the active region 302. In at least one implementation, the reference object is no greater in area than six by six (6×6) pixels.

White balancing may be performed at predefined times or upon the actuation of a white balance control (not shown). Predefined times for white balancing may include white balancing every few time segments (seconds, minutes, etc.), upon the actuation of a control to capture an image (such as movement of a shutter or activation of a shutter button), or the like. When white balancing is performed, a white balance setting is set to an optimum level. White balancing is performed to keep the color of the reference object 306 the same under different illumination conditions. To accomplish this, red and blue channel gains are adjusted to make average red, blue and green components of the reference object 306 equal.

FIG. 3b is a representation of the exemplary image area 300 shown in FIG. 3a. However, the reference object 306 shown in FIG. 3b includes multiple color zones, each having a different color.

In particular, the reference object 306 includes a white zone 308, a black zone 310, a red zone 312, a blue zone 314 and a green zone 316. Although four color zones are shown in FIG. 3b, it is noted that more or fewer color zones may be utilized as described herein. Furthermore, the each color zone may comprise a separate reference object; it is not necessary that the color zones are contiguous. In addition, additional colors not shown herein may be utilized for different types of camera calibration. A reference object may also comprise a color gradient.

The white zone 308 may be used in accordance with the techniques described herein to accomplish white balancing. The black zone 310 may be used as a black level calibration reference, and the red zone 312, blue zone 314 and green zone 316 can be used to adjust red and blue channel gains.

Any calibration method known in the art may be used to calibrate one or more camera settings based on the color zones included in the reference object 306.

Exemplary Multi-Camera Configuration

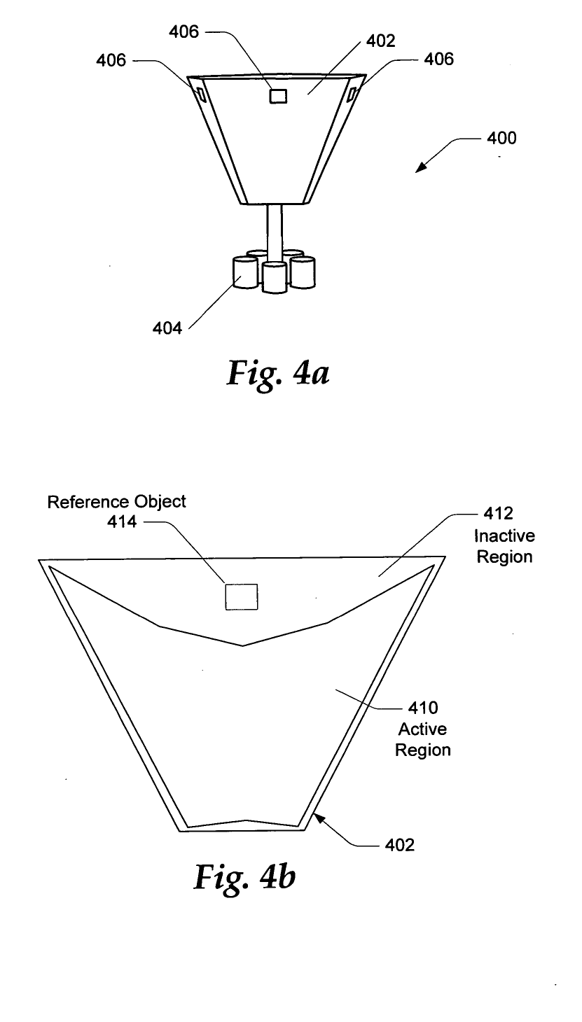

FIG. 4a is a simplified diagram of a multi-camera configuration 400 designed to capture a three hundred and sixty degree (360°) panoramic image. In the following discussion, continuing reference is made to elements and reference numerals shown and described in one or more previous figures.

The multi-camera configuration 400 includes multiple mirrors 402 and multiple cameras 404. One mirror 402 corresponds to one camera 404. Each mirror 402 is of an inverted pyramidal design and is situated such that the camera 404 that corresponds to the mirror 402 can sample an image reflected in the mirror 402.

A reference object 406 is situated on each mirror 402 so that the reference object 406 can be sampled by a camera 404 that corresponds to the mirror 402 on which the reference object 406 is located. However, the reference object 406 is affixed to an area of the mirror 402 so that it is not included in an image produced by the camera 404 even though it is sampled by the camera 404. Such an orientation is described in greater detail below.

The multi-camera configuration 400 shown in FIG. 4a is a five-camera configuration that allows five cameras 404 to each capture an image that can be stitched together to create a single 360° image. Such a configuration may be used in, for example, a conference room where several persons sitting around a conference table may need to be photographed simultaneously. By white balancing each of the cameras 404 with reference to the reference objects 406 (which are typically the same color but could be different if creative video effects are desired), the colors produced by each camera are similar. Thus, when each individual image is stitched together to form a panoramic image, the edges of each individual image—or seams—are not as apparent as they might be if this particular type of white balancing is not performed.

Exemplary Mirror

FIG. 4b is a more detailed diagram of an inverted pyramidal mirror 402 shown in the multi-camera configuration 400 of FIG. 4a. In a multi-camera configuration that utilizes inverted pyramidal mirrors for capturing images from a near-common center of projection, there is a naturally-occurring extended region on each mirror facet on which the reference object may be placed.

An active region 410 of the mirror 402 reflects an image that is captured and re-produced by a corresponding camera 404 (FIG. 4). An extended region 412 of the mirror 402 is imaged by the sensor 210 (FIG. 2) but is not reproduced in a processed output image. A reference object 414 is located in the extended region 412 of the mirror 402 and is used to white balance a camera 404 associated with the mirror 402.

Although the reference object 414 is shown affixed to the mirror 402 in this particular implementation, it is noted that the reference object 414 may be used in photographic devices other than those that use mirrors and the reference object 414 may be located anywhere in proximity to a photographic device as long as the reference object 414 can be imaged by a sensor for use in white balancing.

Exemplary Methodological Implementation

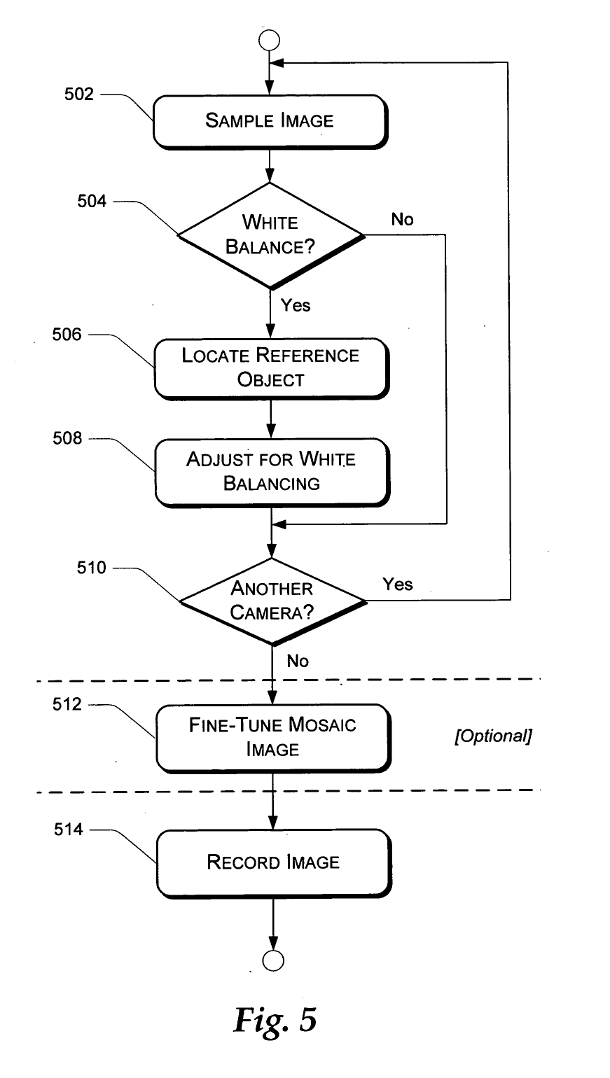

FIG. 5 is a flow diagram 500 of a process for white balancing a photographic device. Although the following discussion deals specifically with a multi-camera configuration, it is noted that the techniques described herein may be utilized with other configurations. In the following discussion, continuing reference is made to the elements and reference numerals shown and described in previous figures.

At step 502, an image is sampled, i.e., the sensor 210 (FIG. 2) receives input from one or more objects in the image area 300 (FIG. 3). The reference object 306 is sampled in the extended region 304 of the image area 300. When white balancing is desired (“Yes” branch, step 504)—such as when a white balance button is actuated or when a pre-specified period of time has elapsed—the reference object 306 is referenced at step 506 and the white balancing module 206 performs a white balancing operation including adjustment of various control settings 207 (step 508). Steps 506 and 508 are skipped when white balancing is not desired (“No” branch, step 504).

If there is another camera to white balance (“Yes” branch, step 510), the process reverts to step 502 and is repeated for the other camera. The process is undertaken for each camera in a multi-camera configuration. It is noted that steps 502 through 508 can be performed contemporaneously in different cameras. However, the process is described here as occurring in each camera separately for purposes of the present discussion.

After white balancing has been completed for each camera (“No” branch, step 510), the white balance of a mosaic image produced from the separate images may be performed at step 512, as described in U.S. patent application Ser. No. 10/177,315, referenced above. However, this step is not required to derive a quality level of white balancing.

At step 514, the image is recorded, processed and/or displayed as a single panoramic image composed from one image from each of the multiple cameras.

Conclusion

While one or more exemplary implementations have been illustrated and described, it will be appreciated that various changes can be made therein without departing from the spirit and scope of the claims appended hereto.

1. A method, comprising:
sampling an image area having an active region for capturing an image and an extended region; and
executing a white balancing procedure with reference to a reference object located in the extended region of the image area.

2. The method as recited in claim 1, wherein the reference object further comprises a white object.

3. The method as recited in claim 1, wherein the reference object further comprises an area of at least four by four (4×4) pixels.

4. The method as recited in claim 1, wherein white balancing is executed whenever an interval of a predetermined period has elapsed.

5. The method as recited in claim 1, further comprising activating a white balance actuator to execute the white balancing.

6. The method as recited in claim 1, wherein the method is performed in a camera and the reference object is fixed to the camera.

7. A camera, comprising:
one or more sensors configured to capture an image from an active region of a detected image area;
a reference object located in an extended region of the image area that is not included in the capture image; and
a white balancing module configured to execute a white balancing operation with reference to the reference object.

8. A photographic device comprising two or more cameras as recited in claim 1.

9. The camera as recited in claim 7, wherein the reference object further comprises a white object.

10. The camera as recited in claim 7, wherein the reference object is fixed to the camera.

11. The camera as recited in claim 7, wherein the reference object further comprises an area of at least four by four (4×4) pixels.

12. The camera as recited in claim 7, wherein the white balancing module is further configured to execute the white balancing operation upon activation of a white balance actuator.

13. The camera as recited in claim 7, wherein the white balancing module is further configured to execute the white balancing operation after a predefined time period has elapsed.

14. The camera as recited in claim 7, wherein the camera further comprises a video camera.

15. One or more computer-readable media containing computer-executable instructions that, when executed on a computer, perform the following steps:
receiving a signal from a sensor, the signal representing an image area;
identifying an image from an active region of the image area;
identifying a reference object from an extended region of the image area; and
executing a white balancing procedure with reference to the reference object.

16. The one or more computer-readable media as recited in claim 15, further comprising a step of determining an appropriate time to initiate the white balancing procedure.

17. The one or more computer-readable media as recited in claim 15, further comprising processing the image from the active region of the image area.

18. The one or more computer-readable media as recited in claim 15, wherein the reference object further comprises a white object.

19. The one or more computer-readable media as recited in claim 15, wherein the reference object further comprises one or more non-white color zones, and further comprising steps of adjusting red and blue channel gains to make color components corresponding to the reference object equal.

20. The one or more computer-readable media as recited in claim 15, wherein the reference object further comprises a black zone, and further comprising the step of adjusting a black level with reference to the black zone of the reference object.

19. A multi-camera photographic device, comprising:
a plurality of cameras, each camera further comprising a reference object that is sampled in an extended region of an image area that includes an active region representing an captured image; and
wherein each camera is configured to execute a white balancing operation with reference to the reference object.

20. The multi-camera photographic device as recited in claim 21, wherein each camera is further configured to fine tune the white balancing operation utilizing overlapping portions of captured images from each camera.

21. The multi-camera photographic device as recited in claim 21, wherein the reference object is a white object.

22. The multi-camera photographic device as recited in claim 21, wherein the reference object is fixed to each camera.

23. A method for use in a multi-camera photographic device, comprising:
for each camera in the multi-camera photographic device, white balancing the camera with reference to a corresponding reference object that is sampled by the camera when the camera samples an image but that is not included in a processed image.

24. The method as recited in claim 25, further comprising fine tuning the white balancing between the cameras utilizing overlapping regions of the image areas from the cameras to adjust the white balance between the cameras and relative to each other.

25. The method as recited in claim 25, wherein the reference objects are white.

26. The method as recited in claim 25, wherein the reference objects are non-white.

27. The method as recited in claim 25, wherein each camera includes a reference object affixed thereto.

28. The method as recited in claim 25, wherein the reference objects further comprise an area of at least four by four (4×4) pixels.

31. The method as recited in claim 25, wherein the cameras further comprises video cameras.

32. The method as recited in claim 25, wherein the white balancing is executed according to a predefined schedule.

33. A method, comprising:
sampling an image area having an active region for capturing an image and an extended region; and
executing at least one color calibration procedure with reference to a reference object located in the extended region of the image area.

34. The method as recited in claim 33, wherein:
the reference object further comprises a white color zone; and
the color calibration procedure further comprises a white balancing procedure.

35. The method as recited in claim 33, wherein:
the reference object further comprises a black color zone; and
the color calibration procedure further comprises a black level calibration procedure.

36. The method as recited in claim 33, wherein:
the reference object further comprises a red color zone; and
the color calibration procedure further comprises a red channel gain calibration procedure.

37. The method as recited in claim 33, wherein:
the reference object further comprises a blue color zone; and
the color calibration procedure further comprises a blue channel gain calibration procedure.

38. The method as recited in claim 33, wherein:
the reference object comprises a first color zone and a second color zone; and
the at least one color calibration procedure further comprises a first color calibration procedure accomplished with respect to the first color zone, and a second color calibration procedure accomplished with respect to the second color zone.
